(19) United States
(12) Patent Application Publication
(10) Pub. No.: US 2004/0019848 A1
(43) Pub. Date: Jan. 29, 2004

(54) Method for dynamically inserting and removing tab text

(76) Inventors: Truc Nguyen, San Diego, CA (US); Katie Kuwata, Oceanside, CA (US); William Su, Corona, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/201,886

(22) Filed: Jul. 24, 2002

(51) Int. Cl. G06F 17/24; G06F 17/21

(52) U.S. Cl. 715/513; 715/517; 715/530

(57) ABSTRACT

A method for dynamically configuring tab text information for a document. An object file is created that stores tab text, attribute and media type information for the document. When the document is processed, the document is merged with the object file, producing an output comprising the document with the tab text data from the object file. The tab text data is structured in at least one self-organized object. Preferably the object file is an XML file. A user interface comprised of independent modules written in XML provides the functionality to add, edit and/or delete the tab text data.

### BACKGROUND OF THE INVENTION

The present invention is generally related to image generating systems and more particularly to a method for dynamically inserting and removing tab text.

A tab, as is commonly known, is the protruding portion of, for example, a sheet of paper that typically extends beyond the general outline of the paper medium to facilitate an indexing function. A tab sheet manufactured to include the tab is used as a document separator in a document compilation to mark the beginning of a section or chapter that comprises the compilation of multiple pages of similar print medium. The tab is usually printed with an alphanumeric text caption to facilitate searching by a user for the section of interest in the compilation. As used in this application, tab text refers to any data, text or graphical, that is printed on the tab portion of the tab sheet.

Earlier systems for tab text comprised superimposing bit maps on the document image. Referring to FIG. 1, there is shown how earlier systems generate an image. A document 10, is overlaid with a bitmap file 12 containing the tab text 14. As shown in FIG. 1 the bitmap file contains an outline of the page, however as those skilled in the art can readily appreciate, the bitmap file may cover the entire page area of the document 10. After the document 10, is overlaid with a bitmap file 12, an image 16 is produced that comprises the document 10 with the tab text 14.

In order to delete tab text in the earlier systems, the system would white out the border around the document to remove the tab text. Modifying a tab text would require first deleting the original tab text, and superimposing another bit map on the document image, or deleting the original bit map file and generating a new bit map file. Because the earlier systems stored the tab text as bit maps to be superimposed on the document, tab text attributes and properties of the media, or any other useful information could not be stored.

Thus, there exists a need for a dynamically configurable system for handling tab text that allows a user to generate and modify tab text information that can be managed through a number of processes, including but not limited to editing, inserting, deleting, copying, etc.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF SUMMARY OF THE INVENTION

In view of the aforementioned needs, the invention contemplates a method and system for dynamically configuring tab text. The method comprising the steps of storing a document, storing tab text data for the document in an object file, and processing the document, wherein the document is merged with the object file, producing an output, the output comprising the document with the tab text data from the object file. Preferably, the tab text is structured in at least one self-organized object, and the object file is an XML file. By using XML, tab text attributes and properties of the media data may also be stored. Furthermore, a user interface providing the functionality to edit and delete the tab text information, preferably comprised of independent modules written in XML enable a user to quickly and easily modify the tab text data.

The present invention also contemplates a computer-readable medium of instructions, comprising means suitably adapted to storing a document, means suitably adapted to storing tab text data for the document in an object file; and means suitably adapted to processing the document, wherein the document is merged with the object file. When the document is merged with the object file, an output is produced. The output comprising the document with the tab text data from the object file.

The present invention further contemplates computer readable instructions stored on a computer readable medium thereon, the computer readable instructions comprising instructions for creating a document, instructions for storing tab text data for the document in an object file, and instructions for processing the document, wherein the document is merged with the object file. When the document is merged with the object file an output is produced. The output comprising the document with the tab text data from the object file.

In addition, the present invention contemplates an image processing apparatus for producing an image comprising a first memory for storing a document, a second memory for storing tab text data for the document in an object file, and a processor for processing the document wherein the document is merged with the object file. When the document is merged with the object file an output is produced, the output comprising the document with the tab text data from the object file.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### BRIEF DESCRIPTION OF THE SEVERAL VIEWS OF THE DRAWING

The drawings illustrate the best mode presently contemplated of carrying out the invention.

In the drawings:

FIG. 1 is a block diagram illustrating the method of adding tab text to a document in the prior art;

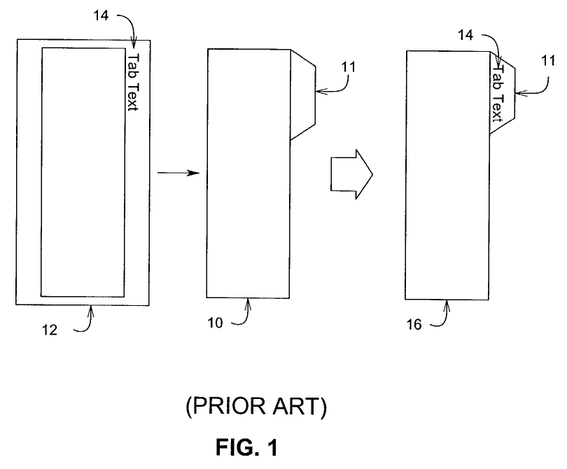

FIG. 2 is a block diagram illustrating the method of the present invention

FIG. 3 is an example of a User Interface to be used with the present invention.

### DETAILED DESCRIPTION OF INVENTION

Throughout this description, the preferred embodiment and examples shown should be considered as exemplars, rather than limitations, of the present invention.

The present invention provides a dynamically configurable tab text system in which tab text is treated as an object stored in an XML file. The XML file store data representative of the tab text, related attributes, and properties of the media on which the tab text is to be printed. The present invention uses an object oriented architecture to process tab text. The tab text information is structured as one or more self-organized objects. The present invention also contemplates providing a user interface that allows a user to generate tab text information that can be easily managed and provides functionality to insert, delete, copy, and edit tab text information. All the process provided by the user interface are similar to the way in which text is handled in a standard word processor application.

The object oriented nature of this invention provides independent program modules written in an XML format that work together as a group at runtime without any prior linking or pre-compilation. Thus, the objects interoperate at runtime strictly through messages passed between them.

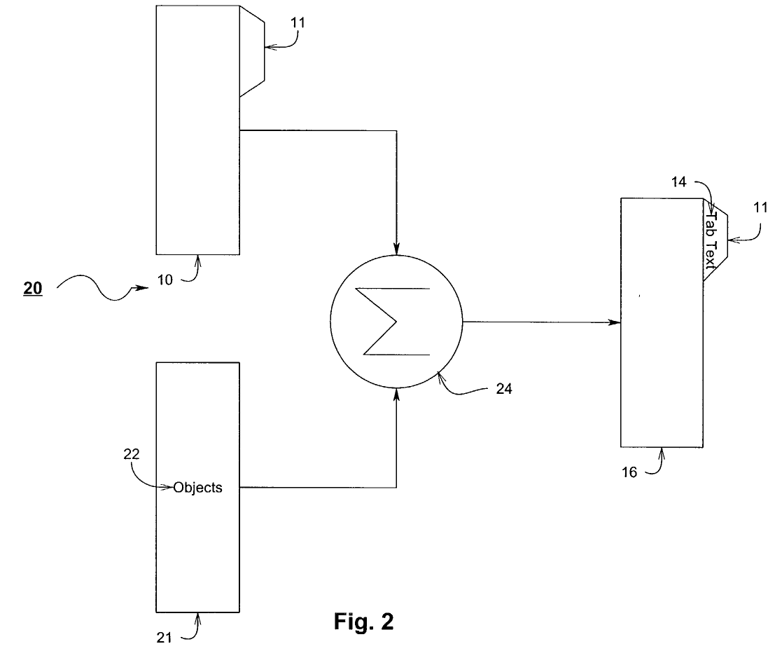

Referring now to FIG. 2 there is shown a block diagram 20 describing the interaction the various features of the present invention. A processor 24 acts as a summer to merge the document 10 with objects 22 stored in an object file 21. Typically, the object file 21 is an XML file and the objects 22 stored in the object file 21 are XML objects. After processing the document 10 and the object file 21, the processor 24 produces an output 16. The output comprising the document 10 and a tab text 14 which is generated by processing the objects 22 stored in the object file 21.

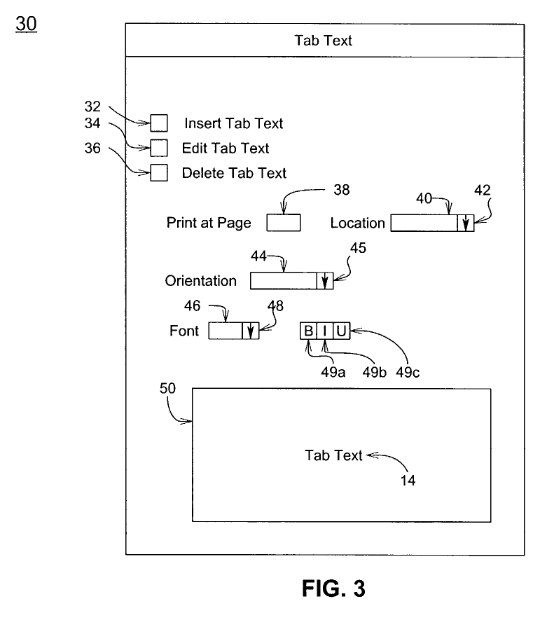

Referring now to FIG. 3, there is shown an example of a user interface 30. By selecting checkboxes 32, 34 or 36 a user can either insert tab texts, edit tab texts, or delete tab texts respectively. At box 38 the user would enter the page to print the tab text onto. The location box 40 enables the user to specify the location on the page where the tab text should be printed. A pre-selected list of locations can be accessed by selecting the arrow 42 next to the box 40 Box 44 allows the user to input the orientation of the tab text, which is typically either Landscape or Portrait. Arrow 45 enables a user to select an orientation from a list of pre-selected orientations. Box 46 enables the user to select the font for the tab text. Arrow 48 can be used to allow the user to select a font from a pre-selected list. Pushbuttons 49a, 49b and 49c enable the user to make the tab texts bold, italicized, or underlined respectively. Text box 50 enables the user to type in the tab text 14 to be printed. As FIG. 3 is an example of the preferred embodiment, the arrangement of the fields and the naming of the fields as limiting as those skilled in the art can readily appreciate that there are many alternatives available.

After the user enters the data into the user interface 30, the data is stored as objects 22 in the object file 21. What follows is an example of the objects 22 being stored in the object file as XML code:

The following example XML code specifies a tab information source file, the source file location, tab text properties, and tab text orientation for placement on the tab paper.

<tabfile>/pbtemp/tab/tab1.png</tabfile>
<tabsource>LC</tabsource>
<tableft>4992</tableft>
<tabtop>100</tabtop>
<tabheight>100</tabheight>
<tabwidth>20</tabwidth>
<tabfontname>Arial</tabfontname>
<tabfontsize>12</tabfontsize>
<taborientation>horizontal</ taborientation >

The following sample XML code specifies the tab orientation and text for various chapter tab sheets in a compilation.

<tabinfo>

<orientation>PORTRAIT</orientation>
<tabtext>Introduction</tabtext>
<tabtext>Chapter 1</tabtext>
<tabtext>Chapter 2</tabtext>
<tabtext>Chapter 10</tabtext>

</tab>

</tabinfo>

Thus, at runtime when the processor 24 of an image forming apparatus (not shown) processes the document 10, the processor simultaneously processes the objects 22 in the object file 21. From the above example, chapter headings, Introduction, Chapter 1, Chapter 2, . . . Chapter 10 will be printed, portrait orientation.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

What is claimed is:

1. A method for dynamically configuring tab text, the steps comprising:
storing a document;
storing tab text data for the document in an object file; and
processing the document, wherein the document is merged with the object file;
wherein an output is produced, the output comprising the document with the tab text data from the object file.

2. The method of claim 1 wherein the tab text data is structured in at least one self-organized object.

3. The method of claim 1 wherein the object file is an XML file.

4. The method of claim 3, the XML file further comprising tab text attribute and properties of media data.

5. The method of claim 1 further comprising providing a user interface that allows a user to generate tab text information

6. The method of claim 5 wherein the user interface provides functionality to edit and delete the tab text information.

7. The method of claim 6 wherein the user interface comprises independent modules written in XML.

8. A computer-readable medium of instructions, comprising:
means suitably adapted to storing a document;
means suitably adapted to storing tab text data for the document in an object file; and
means suitably adapted to processing the document, wherein the document is merged with the object file;
wherein an output is produced, the output comprising the document with the tab text data from the object file.

9. The computer readable medium of claim 8 wherein the tab text data is structured in at least one self-organized object.

10. The computer readable medium of claim 8 wherein the object file is an XML file.

11. The computer readable medium of claim 10, the XML file further comprising tab text attribute and properties of media data.

12. The computer readable medium of claim 8 further comprising providing a user interface that allows a user to generate tab text information.

13. The computer readable medium of claim 12 wherein the user interface provides functionality to edit and delete the tab text information.

14. The computer readable medium of claim 13 wherein the user interface comprises independent modules written in XML.

15. Computer readable instructions stored on a computer readable medium thereon, the computer readable instructions comprising:
instructions for creating a document;
instructions for storing tab text data for the document in an object file; and
instructions for processing the document, wherein the document is merged with the object file;
wherein an output is produced, the output comprising the document with the tab text data from the object file.

16. The computer readable instructions of claim 15 wherein the tab text data is structured in at least one self-organized object.

17. The computer readable instructions of claim 15 wherein the object file is an XML file.

18. The computer readable instructions of claim 17, the XML file further comprising tab text attribute and properties of media data.

19. The computer readable instructions of claim 15 further comprising instructions for providing a user interface that allows a user to generate tab text information

20. The computer readable instructions of claim 19 wherein the instructions for providing a user interface further comprises instructions for functionality to edit and delete the tab text information.

21. The computer readable instructions of claim 20 wherein the user interface comprises independent modules written in XML.

22. An image processing apparatus for producing an image comprising:
a first memory for storing a document;
a second memory for storing tab text data for the document in an object file; and
a processor for processing the document, wherein the document is merged with the object file;
wherein an output is produced, the output comprising the document with the tab text data from the object file.

23. The apparatus of claim 22 wherein the tab text data is structured in at least one self-organized object.

24. The apparatus of claim 23 wherein the object file is an XML file.

25. The apparatus of claim 24, the XML file further comprising tab text attribute and properties of media data.
